(19) United States
(12) Patent Application Publication
(10) Pub. No.: US 2002/0074393 A1
(43) Pub. Date: Jun. 20, 2002

(54) SELF-SERVICE TERMINAL

(76) Inventors: JAMES M. ANDERSON, DUNDEE (GB); ALEXANDER S. MACDONALD, CARNOUSTIE (GB); DAVID S. STEWART, DUNDEE (GB)

Correspondence Address: MICHAEL CHAN, NCR CORPORATION LAW DEPARTMENT, INTELLECTUAL PROPERTY SECTION ECD-2, 101 WEST SCHANTZ AVENUE, DAYTON, OH, 454790001

(21) Appl. No.: 09/378,179

(22) Filed: Aug. 20, 1999

(30) Foreign Application Priority Data
Aug. 20, 1998 (GB) 9818057.3

(51) Int. Cl. G06F 17/60

(52) U.S. Cl. 235/379

(57) ABSTRACT

An ATM for external use is described. The ATM has a security enclosure housing modules for operating the ATM. A fascia is coupled to the enclosure by hinges, and the fascia surrounds a user interface. A plurality of thermally insulating panels are coupled to the enclosure and thermally insulate both the enclosure and the modules from temperatures outside the ATM. The panels are removable so that they can be replaced if damaged.

### BACKGROUND OF THE INVENTION

The present invention relates to a self service terminal, such as a free-standing Automated Teller Machine (ATM).

If a free-standing ATM is located outside a building then it is exposed to possible adverse weather conditions (rain, snow, ice, sunshine), wide temperature variation (between −35 C. and +40 C. depending on the location of the ATM), vandalism, and other influences which may impair the security and/or operation of the ATM.

One known type of ATM has a two-chamber concrete security enclosure and a plastics fascia. There are several disadvantages associated with this design. Concrete deteriorates over a relatively short period of time and if damaged is difficult to repair in the field (i.e. without returning the ATM to a repair site). Concrete is not particularly resistant to high or low extremes of outdoor conditions. In addition, owners of ATMs generally use a particular color scheme to distinguish their ATMs from competitors ATMs, however, concrete is not amenable to color customization.

### SUMMARY OF THE INVENTION

It is an object of the present invention to provide a self-service terminal which is resistant to adverse conditions arising from external use.

According to the invention a self-service terminal for external use comprises: a security enclosure for housing modules for operating the terminal; a fascia for coupling to the enclosure, the fascia surrounding at least part of a user interface of the terminal; characterized in that the terminal further comprises a plurality of thermally insulating panels for removably coupling to the outside of the enclosure.

In use, the panels thermally insulate the enclosure and modules located therein from temperatures outside the terminal and thereby provide a thermally stable environment inside the enclosure.

By virtue of the invention, panels may be used to insulate the modules in a self-service terminal, and the security enclosure provides reinforcement for the panels to give the panels extra rigidity and to provide security against unauthorized access to the modules in the event of damage to the panels. The advantage of having removably coupled panels is that the panels can easily be removed and replaced by a maintenance engineer in the event of them being damaged. The panels are also easily color-customizable. The panels may have a thermal conductivity of less than 50 Wm⁻¹K⁻¹, preferably less than 10 Wm⁻¹K⁻¹, advantageously less than 1 Wm⁻¹K⁻¹, and conveniently less than 0.5 Wm⁻¹K⁻¹. In one embodiment the thermal conductivity of the panels is 0.21 Wm⁻¹K⁻¹ at room temperature.

Preferably, the security enclosure is made of metal or an alloy. Conveniently, the security enclosure is a manganese steel box.

Preferably, the enclosure defines a plurality of chambers. Advantageously, the security enclosure defines at least three chambers. Conveniently, at least one chamber is medium or high security and at least one chamber is low security. The advantage of having at least three chambers is that the walls of the chambers act as structural members which strengthen the enclosure.

Preferably, the terminal further comprises temperature controlling means for controlling the temperature within the enclosure.

Preferably, the fascia is hinged near its upper portion, so that the when the terminal is being serviced, the fascia can be lifted to gain access to the user interface and any modules located behind the fascia. The advantage of having a hinged fascia is that when the fascia is in the raised position it provides some protection to the user interface and the modules from precipitation. Alternatively, the fascia is removably coupled to the enclosure, conveniently by providing mutually interengagable formations on the fascia and the enclosure.

Preferably, the thermally insulating panels are plastics panels. Conveniently, the thermally insulating panels are structural foam panels. The advantages of using structural foam panels are that they provide excellent thermal insulating properties, are readily color-customizable, and physically durable (they do not propagate cracks readily and the surfaces have a degree of elasticity).

Preferably, the fascia and panels are arranged to provide a substantial amount of air sealing so that there is substantial air containment within the enclosure. The advantage of having substantial air containment within the enclosure is that control of the air temperature is improved.

The self-service terminal may be an Automated Teller Machine (ATM) or a kiosk.

### BRIEF DESCRIPTION OF THE DRAWINGS

An embodiment of the invention will now be described, by way of example, with reference to the accompanying drawings, in which:

FIG. 1 is a perspective view of a self-service terminal in the form of an ATM in accordance with one embodiment of the present invention;

FIG. 2 is an exploded perspective view of the ATM of FIG. 1;

FIG. 3 is a perspective view of an enclosure used in the terminal of FIG. 1;

FIG. 4 is a perspective view of the enclosure of FIG. 3 showing two high security chambers and a low security chamber; and

FIG. 5 is a front view of a part of the terminal of FIG. 1, having a fascia in the open position.

### DETAILED DESCRIPTION

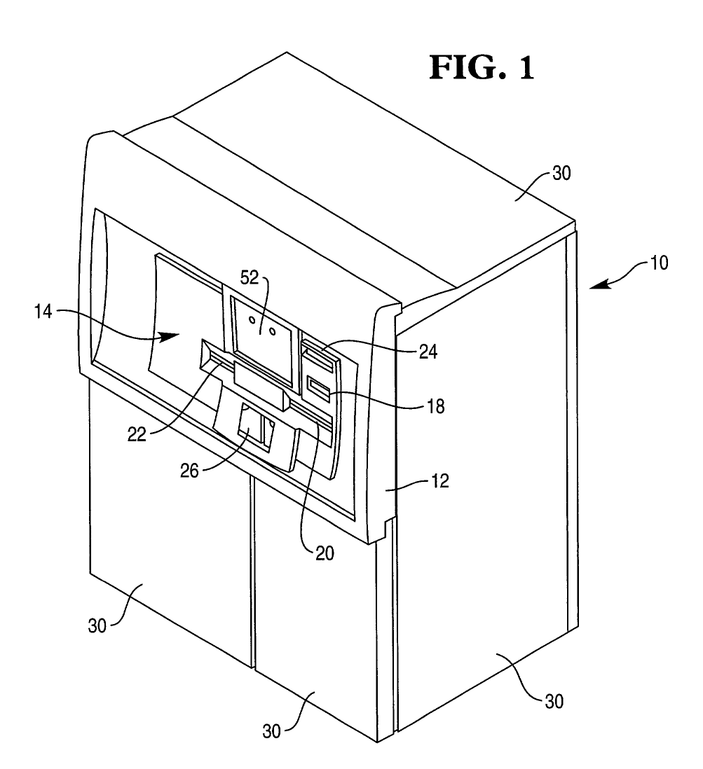

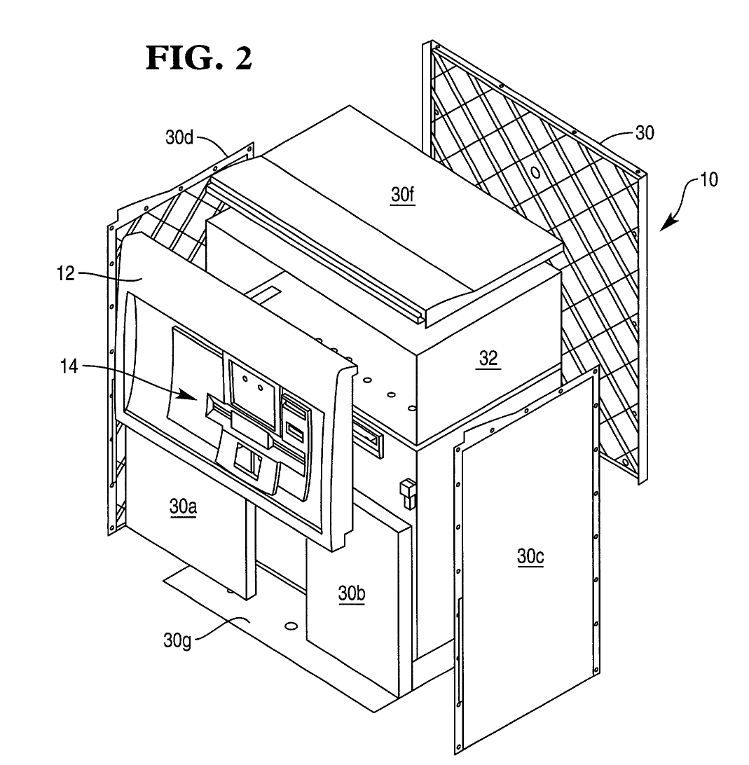

Referring to the drawings, FIG. 1 shows a self-service terminal 10 in the form of an Automated Teller Machine (ATM). The upper portion of the front of the ATM 10 is a plastics fascia 12 made of polycarbonate and incorporating part of a user interface 14. The user interface 14 includes a monitor 16 (FIG. 5), a card reader slot 18, a currency dispensing slot 20, a deposit slot 22, a printer receipt slot 24, and a key pad 26. The other external parts of the ATM 10 are panels 30 made of polycarbonate structural foam having a thermal conductivity of approximately 0.21 Wm⁻¹K⁻¹.

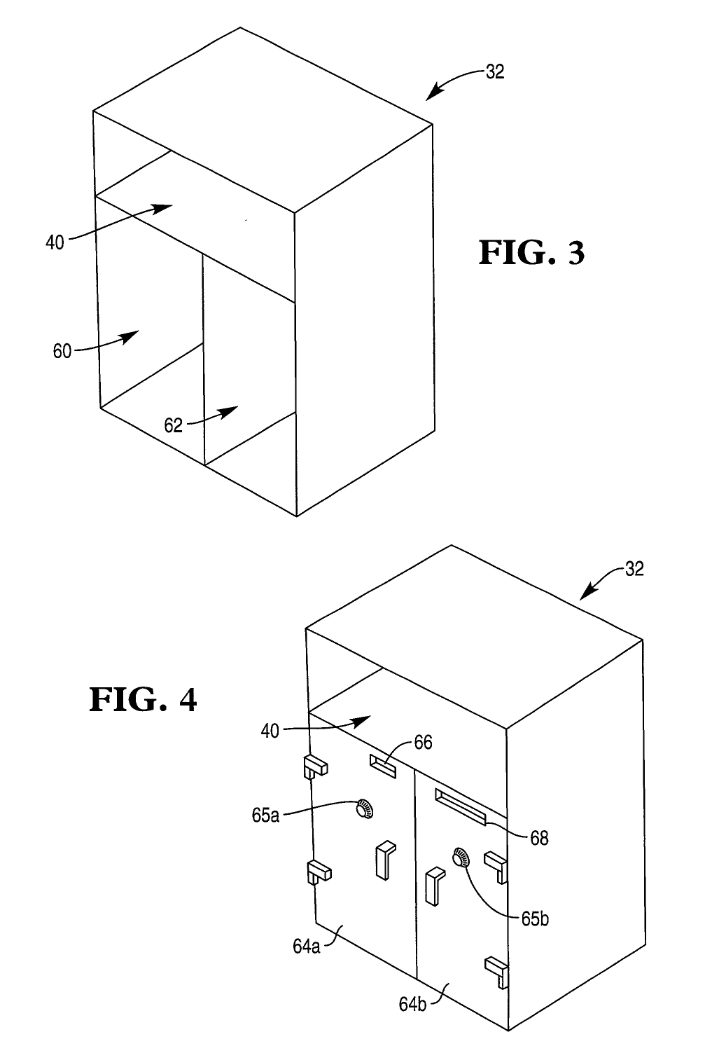

The fascia 12 and panels 30 are coupled to a high security enclosure 32 having solid walls. The enclosure 32 acts as a housing for modules which operate the ATM 10. The fascia 12 and panels 30 are arranged so that they cover substantially all of the enclosure 32. The high security enclosure 32 provides support (reinforcement) for the structural foam panels 30. In this embodiment the enclosure 32 is a three-chamber manganese steel box, which is best shown by FIGS. 3 and 4. The manganese steel box has a wall thickness of approximately 12 cm to provide high security.

The enclosure 32 defines a first (low security) chamber 40 (FIG. 3) having an open front side and which houses the monitor 16, a printer 42 (FIG. 5), a card reader module 44, and a temperature control module 46 which is an air conditioning unit.

The fascia 12 is pivotably mounted to an upper portion of the enclosure 32 by hinges 48; and gas struts 50 couple the fascia 12 to the enclosure 32 to aid raising and lowering of the fascia 12. The fascia 12 is located so that when it is in the lowered (closed) position the open (front) side of the first chamber 40 is closed by the fascia 12 and the card reader slot 18 is aligned with the card reader module 44, and a transparent portion 52 of the fascia 12 is aligned with the monitor 16. When the fascia 12 is in the raised (open) position, frontal access to the first chamber 40 is possible through the open front side. The fascia 12 has a latch 54 which locks the fascia 12 in place when the fascia 12 is in the closed position.

The enclosure 32 also defines two high security chambers 60,62 which are closed by safe doors 64a,b pivotably mounted to the enclosure 32 by hinges.

Chamber 60 houses a deposit drawer (not shown) for storing valuable media, such as cheques, which are deposited in the ATM 10 by a user. Chamber 62 houses currency dispensing cassettes for dispensing currency to a user of the ATM 10. Door 64a controls access to chamber 60 by a combination lock 65a located therein, and door 64a also defines a deposit slot 66 through which cheques may be deposited. Door 64b controls access to chamber 62 by a combination lock 65b located therein, and door 64b also defines a currency slot 68 through which currency is dispensed.

Brackets 70 are mounted on each safe door 64a,b to provide fixings for coupling front panels 30a,b to the doors 64a,b. Side panels 30c,d, rear panel 30e, top panel 30f, and bottom panel 30g are all coupled to the enclosure 32 by screws (not shown).

In use, if one of the panels 30 is damaged then a maintenance engineer can remove the damaged panel and replace it with a new panel. A stable temperature can be maintained within the enclosure of the ATM 10 because the panels 30 and fascia 12 act as thermal insulators thereby providing thermal stability to the air in the enclosure 32.

If one of the modules in the low security chamber 40 fails, then a maintenance engineer can open the fascia 12 to gain access to the faulty module. The fascia 12 provides the modules in chamber 40 with some protection from the elements (rain, hail, snow, and such like) because it pivots upwards. The fascia 12 may also provide the maintenance engineer with some protection as he repairs and/or replaces the faulty module.

Various modifications may be made to the above described embodiment within the scope of the present invention. For example, the enclosure may be made from a different material to manganese steel. The type and thickness of the enclosure material is determined by the level of security required. If a high security chamber is required then the chamber should be able to withstand a pressure of 100 000 psi (6.89476×10⁸ Pa). A manganese steel box having a wall thickness of approximately 12 cm should meet this pressure requirement. If higher security chambers are required then the wall thickness or the type of material selected may be different. Although the embodiment has been described with reference to an ATM, it will be appreciated that the invention is suitable for use with other types of self-service terminal. In other embodiments, only one chamber may be defined by the enclosure. In other embodiments different fascia layouts may be used.

What is claimed is:

1. A self-service terminal for external use, the self-service terminal comprising:
a security enclosure for housing modules for operating the terminal;
a fascia for coupling to the enclosure, the fascia surrounding at least part of a user interface of the terminal; and
a plurality of thermally insulating panels for removably coupling to outside of the security enclosure.

2. A self-service terminal according to claim 1, wherein the security enclosure comprises metal.

3. A self-service terminal according to claim 2, wherein the security enclosure comprises manganese steel.

4. A self-service terminal according to claim 1, wherein the security enclosure defines a plurality of chambers.

5. A self-service terminal according to claim 4, wherein at least one of the chambers is low security and at least one of the other chambers is either medium or high security.

6. A self-service terminal according to claim 1, further comprising temperature controlling means for controlling temperature within the security enclosure.

7. A self-service terminal according to claim 1, wherein the fascia is pivotably coupled to the security enclosure such that the fascia can be raised to gain access to the user interface and any modules located behind the fascia.

8. A self-service terminal according to claim 1, wherein the thermally insulating panels include plastic structural foam panels.

9. A self-service terminal according to claim 8, wherein at least one of the plastic structural foam panels is color-customizable.

10. A self-service terminal according to claim 1, wherein the fascia and the thermally insulating panels are arranged to provide a substantial amount of air sealing so that there is substantial air containment within the security enclosure.

11. An automated teller machine (ATM) for external use, the ATM comprising:
a security enclosure for housing modules for operating the ATM;
a fascia for coupling to the enclosure, the fascia surrounding at least part of a user interface of the ATM; and
a plurality of thermally insulating panels for removably coupling to outside of the security enclosure.

12. An ATM according to claim 11, wherein the security enclosure comprises metal.

13. An ATM according to claim 12, wherein the security enclosure comprises manganese steel.

14. An ATM according to claim 11, wherein the security enclosure defines a plurality of chambers.

15. An ATM according to claim 14, wherein at least one of the chambers is low security and at least one of the other chambers is either medium or high security.

16. An ATM according to claim 11, further comprising temperature controlling means for controlling temperature within the security enclosure.

17. An ATM according to claim 11, wherein the fascia is pivotably coupled to the security enclosure such that the fascia can be raised to gain access to the user interface and any modules located behind the fascia.

18. An ATM according to claim 11, wherein the thermally insulating panels include plastic structural foam panels.

19. An ATM according to claim 18, wherein at least one of the plastic structural foam panels is color-customizable.

20. An ATM according to claim 11, wherein the fascia and the thermally insulating panels are arranged to provide a substantial amount of air sealing so that there is substantial air containment within the security enclosure.
